(19) United States
(12) Patent Application Publication
(10) Pub. No.: US 2024/0268438 A1
(43) Pub. Date: Aug. 15, 2024

(54) FOOD COATING WITH IMPROVED OILING OUT PROPERTIES

(71) Applicant: SOCIETE DES PRODUITS NESTLE S.A., Vevey (CH)

(72) Inventors: LAURENT SAGALOWICZ, Blonay (CH); PATRICIA ROSSI VAUTHEY, Rivaz (CH); FABIOLA DIONISI, Epalinges (CH); STEPHANIE MARTY-TERRADE, Les Hopitaux-Neufs (FR); FEDERICO ROTA, Lausanne (CH); ZEYNEL DENIZ GUNES, Lausanne 27 (CH); MAOZ GROPPER, Neve Yahud Monoson (IL); MOR ALON ZAITOUN, Kochav Michael (IL); RICARDO RODRIGUEZ, Santiago (CL)

(21) Appl. No.: 18/567,474

(22) PCT Filed: Jun. 7, 2022
(86) PCT No.: PCT/EP2022/065390

§ 371 Date: Dec. 6, 2023

(30) Foreign Application Priority Data
Jun. 7, 2021 (EP) 21178048.1

(51) Int. Cl. A23P 20/10; A23L 7/122; A23L 19/12

(52) U.S. Cl. CPC A23P 20/10; A23L 7/122; A23L 19/12

(57) ABSTRACT

The present invention relates to a foodstuff comprising a food coating on its exterior surface, wherein said food coating comprises i) between 50% and 95% of a nut paste or legume paste; ii) between 1% and 30% of a liquid oil, wherein said liquid oil is not from the same source as the paste; and iii) between 5% and 30% of a flour; and wherein the food coating does not comprise palm oil, and wherein between 5 to 100% of the foodstuff exterior surface is in direct contact with the food coating.

### INTRODUCTION

Food products with a food coating rich in nut paste or legume paste often have the issue that the paste can have a low viscosity, which makes the food coating diffuse too fast towards the product interior or to flow onto processing equipment or packaging. This creates issues with taste, equipment hygiene, food packaging, and packaging equipment. It is therefore desirable to decrease oiling out and to increase viscosity.

Common solutions include the use of additives which promote fat crystallization. WO2005089568A1 describes the use of mono- and/or di-glycerides, alpha tending emulsifiers and ionic co-emulsifiers as a shortening. The disadvantage is that the most common and cheapest emulsifiers require an E-number and so do not meet consumer expectations of clean labelling.

EP 1178731 describes a shortening where wax is added to promote crystallization and replace saturated fat. The use of wax as an ingredient may also create labelling problems as well as a waxy taste in the mouth. Palm oil can also be added to the paste, but this tends to increase the saturated fat content and has been widely challenged with regard to its sustainability as an ingredient.

### SUMMARY OF INVENTION

An object of the present invention is to improve the state of the art and to provide an improved solution to overcome at least some of the above disadvantages or at least to provide a useful alternative. Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

The invention relates in general to a food coating, wherein said food coating comprises a nut paste or legume paste; a liquid oil; and a flour.

The invention further relates to a food coating, wherein said food coating comprises a nut paste or legume paste; a liquid oil, wherein said liquid oil is not from the same source as the paste; and a flour; and wherein the food coating does not comprise palm oil.

The invention further relates to a food coating, wherein said food coating comprises
i) between 50% and 95% of a nut paste or legume paste;
ii) between 1% and 30% of a liquid oil, wherein said liquid oil is not from the same source as the paste; and
iii) between 5% and 30% of a flour;
and wherein the food coating does not comprise palm oil.

In particular, the invention relates to a foodstuff comprising a food coating on its exterior surface, wherein said food coating comprises
i) between 50% and 95% of a nut paste or legume paste;
ii) between 1% and 30% of a liquid oil, wherein said liquid oil is not from the same plant source as the paste; and
iii) between 5% and 30% of a flour;
and wherein the food coating does not comprise palm oil, and wherein between 5 to 100% of the foodstuff exterior surface is in direct contact with the food coating.

In one embodiment, said food coating comprises
i) between 60% and 95% of a nut paste or legume paste, preferably between 70% and 92%, more preferably between 75% and 90%;
ii) between 2% and 20% of a liquid oil, preferably between 3% and 18%, more preferably between 3% and 12%; and
iii) between 6% and 25% of a flour, more preferably between 7 and 22%.

In one embodiment, the foodstuff and/or the coating do not comprise animal or animal derived products.

In one embodiment, the food coating comprises a nut paste or legume paste, liquid oil and flour, and wherein the food coating displays lower oiling out compared to the same food coating which does not comprise liquid oil and flour.

In one embodiment, the food coating comprises nut paste or legume paste, liquid oil and flour, and wherein the food coating has a higher viscosity compared to the same food coating which does not comprise liquid oil and flour.

In one embodiment, the ratio of liquid oil:flour is between 5:1 to 1:6, more preferably between 4:1 to 1:5, more preferably between 3:1 to 1:4, more preferably between 3:2 to 1:3.

In one embodiment, the flour, or the flour and liquid oil combined, have a saturated fat content less than 30%, more preferably less than 20%, more preferably less than 15%, more preferably less than 12%, more preferably less than 9%.

In one embodiment, the flour has a D50 diameter in the range of 1 to 600 microns as measured by light scattering, more preferably 2 to 400 microns, more preferably 3 to 300 microns, more preferably 4 to 200 microns, more preferably 5 to 150 microns.

In some embodiments, the nut paste is Brazil nut paste. In one embodiment, the nut paste is a mixture of Brazil nuts and cashew nuts. In one embodiment, the nut paste is peanut paste. In one embodiment, peanut paste comprises about 28% protein, about 12% carbohydrate, about 48.5% of fat and about 7% fibre.

In one embodiment, the liquid oil is selected from sunflower oil, canola oil, colza oil, rapeseed oil, soya oil, olive oil, pumpkin oil, rapeseed oil, linseed oil, Hemp oil, chia oil, high oleic sunflower oil, peanut oil, soy bean, safflower oil, corn oil, algae oil, cottonseed oil, grape seed oil, flaxseed oil, rapeseed oil, primrose oil, linseed oil, avocado oil, a nut oil such as hazelnut oil, walnut oil, macadamia nut oil, or other nut oil, rice bran oil, sesame oil, or combinations thereof. In one embodiment, the liquid oil is a high oleic liquid oil. A high oleic liquid oil is made from a seed enriched in oleic acid and has a reduced saturated fat content.

In one embodiment, the oil is high oleic sunflower oil. In one embodiment, the oil is olive oil. In one embodiment, the oil is canola oil.

In one embodiment, the flour is derived from a legume, a vegetable or an oilseed source. In one embodiment, the flour is defatted or partially defatted, wherein the defatted flour comprises about 45% protein, about 12% fiber, about 15% carbohydrate, and about 12% fat. In one embodiment, the flour contains less than 30% lipid, more preferably less than 20% lipid, more preferably less than 15% lipid.

In one embodiment, the flour is sunflower flour. In one embodiment, the sunflower flour is partially defatted and comprises, for example, about 45% protein, about 12% fibres and about 12% of fat. In one embodiment, the flour is carrot flour. In one embodiment, the flour is peanut flour. In one embodiment, the peanut flour is partially defatted and comprises, for example, about 50% protein, about 12% fat and about 16% fibres.

In one embodiment, the nut paste is a Brazil nut paste, the oil is a high oleic sunflower oil, and the flour is a sunflower flour, for example about 70% Brazil nuts, about 8% high oleic sunflower oil, and about 22% sunflower flour. In one embodiment, the sunflower flour is defatted.

In one embodiment, the nut paste is peanut paste, the oil is olive oil, and the flour is a peanut flour, for example about 75% peanut paste, about 9% olive oil, and about 16% peanut flour.

In one embodiment, the nut paste is peanut paste, the oil is canola oil, and the flour is a peanut flour, for example about 85% peanut paste, about 7% canola oil, and about 8% peanut flour.

In one embodiment, the nut paste is peanut paste, the oil is canola oil, and the flour is a sunflower flour, for example about 85% peanut paste, about 3% canola oil, and about 12% sunflower flour.

In one embodiment, the nut paste is a blend of Brazilian nuts and cashew nuts, the oil is olive oil, and the flour is a carrot flour, for example about 42% Brazil nuts and 28% cashew nuts, about 24% olive oil, and about 6% carrot flour.

The invention further relates to a method of making a coated foodstuff, said method comprising the application of a food coating on an exterior surface of the foodstuff, wherein the food coating is made by mixing (i) nuts or legume seeds with liquid oil and flour; or (ii) nut paste or legume paste with liquid oil and flour. In one embodiment, the mixing step comprises high shear mixing, milling, grinding or micronizing. In one embodiment, the mixing step is performed using a mixer, a high shear mixer, a mixer using a blade or an extrusion machine. In one embodiment, said method comprises the steps of mixing nut paste or legume paste with at least a portion of liquid oil, refining the mixture, combining with flour and remaining oil, and optionally other ingredients.

In one embodiment, the food coating comprises
i) between 50% and 95% of a nut paste or legume paste;
ii) between 1% and 30% of a liquid oil, wherein said liquid oil is not from the same plant source as the paste; and
iii) between 5% and 30% of a flour;
   and wherein the food coating does not comprise palm oil.

In one embodiment, the food coating is applied to the foodstuff so that between 5 to 100% of the foodstuff exterior surface is in direct contact with the food coating.

In one embodiment, said food coating comprises
i) between 60% and 95% of a nut paste or legume paste, preferably between 70% and 92%, more preferably between 75% and 90%;
ii) between 2% and 20% of a liquid oil, preferably between 3% and 18%, more preferably between 3% and 12%; and
iii) between 6% and 25% of a flour, more preferably between 7 and 22%.

In one embodiment, the foodstuff and/or the food coating do not comprise animal or animal-derived products.

In one embodiment, the food coating comprises a nut paste or a legume paste, liquid oil and flour, and wherein the food coating displays lower oiling out compared to the same food coating which does not comprise liquid oil and flour. In one embodiment, the food coating comprises a nut paste or a legume paste, liquid oil and flour, and wherein the food coating has a higher viscosity compared to the same food coating which does not comprise liquid oil and flour. In one embodiment, the ratio of liquid oil:flour is between 5:1 to 1:6, more preferably between 4:1 to 1:5, more preferably between 3:1 to 1:4, more preferably between 3:2 to 1:3. In one embodiment, the flour, or the flour and liquid oil combined, have a saturated fat content less than 30%, more preferably less than 20%, more preferably less than 15%, more preferably less than 12%, more preferably less than 9%. In one embodiment, the flour has a D50 diameter in the range of 1 to 600 microns, more preferably 2 to 400 microns, more preferably 3 to 300 microns, more preferably 4 to 200 microns, more preferably 5 to 150 microns.

In one embodiment, the liquid oil is selected from sunflower oil, canola oil, colza oil, rapeseed oil, soya oil, olive oil, pumpkin oil, rapeseed oil, linseed oil, Hemp oil, chia oil, high oleic sunflower oil, peanut oil, soy bean, safflower oil, corn oil, algae oil, cottonseed oil, grape seed oil, flaxseed oil, rapeseed oil, primrose oil, linseed oil, avocado oil, a nut oil such as hazelnut oil, walnut oil, macadamia nut oil, or other nut oil, rice bran oil, sesame oil, or combinations thereof. In one embodiment, the liquid oil is a high oleic liquid oil.

In one embodiment, the flour is derived from a legume, a vegetable or an oilseed source. In one embodiment, the flour contains less than 30% lipid, more preferably less than 20% lipid, more preferably less than 15% lipid.

In one embodiment, the foodstuff comprises chocolate, potatoes, or cereals.

### DETAILED DESCRIPTION

The inventors of the present invention have surprisingly found food coating compositions with good organoleptic properties can be prepared by partial or total replacement of fats with an additional component in combination with a liquid oil, without compromising the texture and organoleptic properties of the food coating, as well as the shelf-life properties (e.g. oiling out). Fats can be solid or liquid at room temperature and have a saturated fatty acid content greater than 30 wt % with reference to the total fat.

Oil release, or oil leakage or oiling out, is an important technological feature of a food coating. An increased oil release from the food coating leads to a diffusion of oil, for example into the surrounding food packaging material. Free oil, released from the continuous food coating mass, is also detrimental for a proper mouthfeel. Moreover, the amount of released oil over time governs the storage stability of the food coating. As shown in the examples of the present invention, the food coating compositions of the present invention display advantageous properties in this regard, i.e. similar to or better than the reference food coating compositions.

Viscosity is also an important parameter since a food coating with higher viscosity would lead to less penetration of the food coating in the product interior and less loss of the food coating onto product equipment and packaging.

In the present context, the term “food coating” relates to a pre-prepared composition to be used as one part of a composite product. The food coating and the other part(s) of the composite product are composed of different components. Preferably, the food coating surrounds the other part(s) of the composite product.

### Nut Paste or Legume Paste

The food coating comprises a paste derived from a nut or a legume. In an embodiment, the paste is a combination of solids and liquid fats. In one embodiment, the liquid fat may be a liquid oil.

In one embodiment, the paste comprises liquid oil in an amount of greater than 5% by weight of the paste, preferably greater than 10% by weight, preferably greater than 15% by weight, preferably greater than 20%, preferably greater than 25% and preferably greater than 30%. In one embodiment, the paste comprises liquid oil in an amount of less than 75% by weight, preferably less than 70% by weight, 65% by weight, preferably less than 60% by weight and most preferably less than 55% by weight. For example, between 5% and 65%.

In one embodiment, the paste comprises solid in an amount of greater than 25% by weight of the paste, preferably greater than 30% by weight of the paste, preferably greater than 35% by weight of the paste, preferably greater than 40% by weight, and preferably greater than 45% by weight.

In one embodiment, the viscosity of the nut paste or legume paste at a shear rate of 1 s-1 is between 500 mPa s and 200 000 mPa s, preferably between 1000 mPa s and 100000 mPa s, preferably between 5000 mPa s and 30000 mPa s.

In one embodiment, the viscosity of the nut paste or legume paste at a shear rate of 10 s-1 is between 300 mPa s and 100 000 mPa s, preferably between 800 mPa s and 40000 mPa s, preferably between 2000 mPa s and 15000 mPa s.

In one embodiment, the viscosity of the nut paste or legume paste at a shear rate of 100 s-1 is between 200 mPa s and 60 000 mPa s, preferably between 500 mPa s and 25000 mPa s, preferably between 1000 mPa s and 10000 mPa s.

In one embodiment, the paste flows under gravity.

In one embodiment the paste is a legume paste. In one embodiment, the paste is a nut paste.

In one embodiment the paste comprises chestnuts, groundnuts, hazelnuts, Brazilian nut, almond, peanut, cashew nut, pistachio, sunflower seed, pumpkin seed, walnut, or combinations thereof.

In one embodiment the paste comprises peanuts or groundnuts. In one embodiment the paste comprises Brazilian nuts. In one embodiment the paste comprises Cashew nuts.

### Liquid Oil

The amount of liquid oil referred to herein does not include the liquid oil component of the nut paste or legume paste. The liquid oil used for preparing the food coating can be any vegetable oil or fat that is liquid or that can be liquefied at ambient conditions. The oil is suitably a food grade oil. Examples include sunflower oil, rapeseed oil, olive oil, soy oil, colza oil, canola oil, soy bean, fish oil, linseed oil, safflower oil, corn oil, algae oil, cottonseed oil, grape seed oil, flaxseed oil, rapeseed oil, primrose oil, linseed oil, avocado oil, a nut oil such as hazelnut oil, walnut oil, macadamia nut oil, or other nut oil, peanut oil, rice bran oil, sesame oil, or combinations thereof. The above oils may be optionally hydrogenated (partially or fully) and optionally inter-esterified. Optionally, the oil can contain one or more liposoluble compounds; such as for example plant polyphenols, fatty acids, such as n-3 fatty acids, n-6 fatty acids, vitamins, aromas, flavours, antioxidants, other active ingredients. Preferred antioxidants include ascorbic acid, ascorbyl palmitate, citric acid, rosmarin extract, BHA (Butylated hydroxyanisole), BHT (Butylated hydroxytoluene), mixed tocopherol, and EDTA (Ethylenediaminetetraacetic acid).

Preferably, a vegetable oil is used, more preferably an oil with a low SFA content is chosen such as high oleic sunflower oil or high oleic rapeseed oil.

The above liquid oils may have differing oleic acid contents. For example, sunflower oil may be (% by weight): Conventional oil or high linoleic acid: 14.0%<Oleic acid<43.1% (i.e. between 14.0% and 43.1% oleic acid), Mid Oleic: 43.1%<Oleic acid<71.8%, High oleic: 71.8%<Oleic acid<90.7%, Ultra/Very-high oleic, 90.7<oleic acid. For example, safflower oil: conventional oil:8.4%<Oleic acid<21.3%; and High oleic: 70.0%<Oleic acid<83.7%. Additionally, high oleic acid variants of the following oils are available, soybean oil (70.0%<Oleic acid<90.0%), rapeseed oil (70.0%<Oleic acid<90.0%), olive oil (70.0%<Oleic acid<90.0%), canola (70.0%<Oleic acid<90.0%), and algae oil (80.0%<Oleic acid<95.0%).

In other embodiments, the liquid oil may be medium-chain triglycerides, preferably triglycerides where the fatty acids have an aliphatic tail of 6-12 carbon atoms. These oils may be obtained, for example, from coconut oil, or palm kernel oil.

### Flour

Preferably, the flour has a high protein content, preferably having a protein content of more than 15%, more preferably at least 20%, more preferably at least 30%, more preferably at least 40% protein by total weight of flour.

In one embodiment, the flour is derived from a legume. In one embodiment, the flour is derived from an oil seed. In one embodiment, the flour is derived from nuts.

In one embodiment, the flour is derived from a mixture of legumes, or oil seeds or nuts or combinations thereof. In one embodiment, the flour is derived from a different plant source than the paste.

In one embodiment, the flour is a powder. In one embodiment, the flour is composed of solid particles.

In one embodiment, the flour is derived from chickpea, beans, peanuts, groundnuts, lentils and peas, for example kidney beans, navy beans, pinto beans, haricot beans, lima beans, butter beans, azuki beans, mung beans, golden gram, green gram, black gram, urad, fava beans, scarlet runner beans, rice beans, garbanzo beans, cranberry beans, lima beans, green peas, snow peas, snap peas, split peas and black-eyed peas, for example sunflower seeds, cottonseeds, pumpkin, hemp, chia and flaxseeds, for example hazelnuts, brazil nuts, pilinuts, cashew nuts, macadamia nuts, tiger nuts, peanuts, pecan nuts, pili nuts, pine nuts, pistachio, chestnuts, pecan nuts.

In one embodiment, the flour is derived from sunflower seeds. In one embodiment, the flour is derived from peanuts. In one embodiment, the flour is derived from groundnuts. In one embodiment, the flour is defatted.

### Ratio of Liquid Oil to Flour

Preferably, the ratio of liquid oil:flour is between 5:1 to 1:6, more preferably between 4:1 to 1:5, more preferably between 3:1 to 1:4, more preferably between 3:2 to 1:3.

### Food Product Comprising Food Coating

An embodiment of the present invention provides a food product comprising the food coating composition of the present invention, preferably the food product is a confectionery product.

In one embodiment, the food product has a saturated fat content less than 10%, preferably less than 7%, preferably less than 4.9%, preferably less than 4.5%, preferably less than 4%.

In one embodiment, the food coating is in direct contact with at least a portion of the food product. In an embodiment, the food coating is in direct contact with at least 5% of the exterior surface area of the food product, preferably at least 10%, at least 20%, at least 30% or at least 40%. In an embodiment, the food coating is in direct contact with 100% of the exterior surface area of the food product, less than 95%, less than 90%, less than 80% or less than 75%. For example, between 5% and 100% of the exterior surface area of the food product is in direct contact with the food coating.

In an embodiment, the food coating is deposited on the outside after the product interior has been processed. Food coating can be deposited by spraying (e.g. Nozzle deposition), mixing the product interior with the food coating (e.g. using a kitchen or an industrial mixer such as a drum mixer).

In an embodiment, the food product is in direct contract with at least 5% of the interior surface area of the food coating, preferably at least 10%, at least 20%, at least 30% or at least 40%. In an embodiment, the food product is in direct contact with 100% of the interior surface area of the food coating, less than 95%, less than 90%, less than 80% or less than 75%. For example, between 5% and 100% of the interior surface area of the food coating is in direct contact with the food product.

In one embodiment, the food coating of the present invention is not-baked, i.e. it is not included on a food product which requires further cooking after the food coating has been deposited.

In an embodiment, provided is a coated foodstuff product, that comprises from 5 to 95% by weight of the product of the food coating of the invention, preferably from 10 to 90%, preferably from 20 to 70% or from 30 to 50%.

The food product has a different recipe and/or nutritional composition compared to the food coating. In one embodiment, the food product comprises chocolate. In one embodiment, the food product comprises potato. In one embodiment the food product comprises cereal, for example extruded cereal. In one embodiment the food product comprises peanut. In one embodiment the food product comprises rice.

### Method of Making Food Coating

The mixing of the ingredients can be carried out by conventional mixing, refining, and/or aeration methods, for instance using standard industrial mixing apparatus.

In one embodiment, nut paste or legume paste, the flour and the liquid oil are mixed sequentially, simultaneously and/or in any order. The mixture can be refined at any time. In general, any kind of mixer, milling machine or grinding machine can be used to mix the ingredients.

In one embodiment, equipment used to mix or prepare the ingredients can be a ball mill, preferably a Wiener ball mill, a stone mill, a colloidal mill, a grinding mill or a grinding machine a mixer, a high shear mixer, a mixer using a blade or an extrusion machine.

In one embodiment, provided is a method of making the food coating of the present invention comprising the steps of mixing nuts, legumes, nut paste or legume paste (and optionally the flour) with at least a portion of liquid oil, refining the mixture, and optionally combining with flour and any remaining oil, along with any remaining ingredients.

In one embodiment, the nut paste or legume paste can be made in-situ starting from entire or dehulled nuts or legume seeds. The nuts or legume seeds are refined on their own or simultaneously with part or all of the flour, and/or part or all of the liquid oil, and processed to obtain a nut paste or legume paste. Optionally the mixture, the nut paste or legume paste can be then mixed and or refined with part or all of the flour, or with part or all of the liquid oil. The process for mixing or refining the mixture includes whole or dehulled nut or legume seeds include mixing, high shear mixing, milling, grinding or micronizing, extrusion, a mixer, a high shear mixer, a mixer using a blade or an extrusion machine. The process for preparing the paste from complete or dehulled nut or legume seeds include mixing, high shear mixing, milling, grinding or micronizing, extrusion, a mixer, a high shear mixer, a mixer using a blade or an extrusion machine.

Mixing or refining. processes can include the use of ball mill, preferably a Wiener ball mill, a stone mill, a colloidal mill, a grinding mill or a grinding machine.

Nuts or legume seeds include chestnuts, groundnuts, hazelnuts, Brazilian nut, almond, peanut, cashew nut, pistachio, sunflower seed, pumpkin seed walnut, or combinations thereof.

### Refining

One or more of the food coating ingredients may be refined. In one embodiment, the refining step provides a particle size of less than 200 microns, preferably less than 100 microns, preferably less than 75 microns and preferably less than 60 microns. In an embodiment, the particles size provided by refining is greater than 10 microns, preferably greater than 25 microns and preferably greater than 30 microns. In one embodiment, the particle size is between 10 microns and 200 microns, preferably between 25 microns and 75 microns.

The refining may be carried out by any appropriate refining apparatus for the production of foodstuffs with the above particle sizes, for example, a 2-roll and/or 5-roll refiner. Alternatively, refining may be carried out with any kind of mill or grinding machine. Alternatively, refining may be carried out with a ball mill, preferably a Wiener ball mill, preferably a temperature greater than room temperature, preferably between 40° C. and 60° C. Alternatively, refining may be carried out with a stone mill, a colloidal mill, a grinding mill or a grinding machine. Alternatively, refining may be carried out with a mixer, a high shear mixer or a mixer using a blade.

The sieving may preferably be carried out using a sieve with a 0.6 mm or less mesh size, preferably a 0.5 mm or less mesh size, and preferably a 0.2 mm or greater mesh size, most preferably a 0.4 mm sieve mesh size.

### General Terminology

Unless defined otherwise, all technical and scientific terms used herein have and should be given the same meaning as commonly understood by one of ordinary skill in the art to which this invention belongs.

Unless the context clearly indicates otherwise, as used herein plural forms of the terms herein are to be construed as including the singular form and vice versa.

In all ranges defined above, the end points are included within the scope of the range as written. Additionally, the end points of the broadest ranges in an embodiment and the end points of the narrower ranges may be combined.

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non exhaustive the sum of the percentage for each of such components may be less than 100% to allow a certain percentage for additional amount(s) of any additional component(s) that may not be explicitly described herein.

As used herein, “about” and “approximately” are understood to refer to numbers in a range of numerals, for example the range of −30% to +30% of the referenced number, preferably within −20% to +20% of the referenced number, more preferably within −10% to +10% of the referenced number, most preferably within −5% to +5% of the referenced number.

The term “substantially” as used herein may refer to a quantity or entity to imply a large amount or proportion thereof. Where it is relevant in the context in which it is used “substantially” can be understood to mean quantitatively (in relation to whatever quantity or entity to which it refers in the context of the description) there comprises an proportion of at least 80%, preferably at least 85%, more preferably at least 90%, most preferably at least 95%, especially at least 98%, for example about 100% of the relevant whole. By analogy the term “substantially-free” may similarly denote that quantity or entity to which it refers comprises no more than 20%, preferably no more than 15%, more preferably no more than 10%, most preferably no more than 5%, especially no more than 2%, for example about 0% of the relevant whole. Preferably, where appropriate (for example in amounts of ingredient) such percentages are by weight.

As used herein, unless the context indicates otherwise, standard conditions for measuring if a fat is liquid or solid, means, atmospheric pressure, a relative humidity of 50%±5%, ambient temperature (20° C.±2°) and an air flow of less than or equal to 0.1 m/s. Unless otherwise indicated all the tests herein are carried out under standard conditions as defined herein.

It should be noted that embodiments and features described in the context of one of the aspects or embodiments of the present invention also apply to the other aspects of the invention.

### Particle Size Measurement

D50 in volume is used. D50 in volume is also known as volume median or volume average particle size. It physically represents that each volume of particles greater or smaller than such value takes account of 50% of the total particles volume. It is a way to have median diameter.

The particle size distribution and D50 can be determined using light scattering, for example using a Mastersizer 2000 using the Frauenhofer model, speed 2600 rpm, in oil, with a refractive index 0. Particle size can be also determined using a CamSizer instrument (Camsizer XT Retsch Xdry, using a pressure of 120 Pa, the results being expressed on a volume basis with the Xₐᵣₑₐ, manual Camsizer) and the D50 in volume can be obtained.

The invention will now be described in further details in the following non-limiting examples.

### EXAMPLES

### Example 1

70% Brazil nuts (Migros, Switzerland), 22% sunflower flour (Heliaflor 45, AOT, Germany) and 8% High oleic sunflower oil were mixed using a Thermomix at a speed of 5 for 3 minutes at room temperature to make a homogeneous food coating. Brazilian nut paste was obtained using a Thermomix at a speed of 5 during 3 minutes at room temperature. A homogenous mixture was formed. Sunflower flour is obtained from partially defatted sunflower and contains about 45% protein, 12% fiber and 12% of fat.

Part of the sample was analysed. Rheology results of the mixture including Brazilian nut paste, sunflower flour and high oleic sunflower oil were compared to the rheology results of the starting materials (peanut paste). Viscosity was measured using a Physica MCR 501 (Anton Paar) with a Pelletier temperature at 25° C., with 50 points for 6 seconds for a shear rate of 0.1 to 100 s-1. A plate to plate geometry was used.

At a shear rate of 1 s-1, the viscosity for the Brazilian nut paste was 3084 mPa s, while viscosity of the total mixture was 7195 mPa s. At a shear rate of 10 s-1, viscosity for the Brazilian nut paste on its own was 1937 mPa s while viscosity of the total mixture was 4753 mPa s. At a shear rate of 100 s-1, viscosity for the Brazilian nut paste on its own was 1616 mPa s while viscosity of the total mixture is 3668 mPa s.

Oiling out was measured by placing the food coating including Brazilian nut paste, sunflower flour and high oleic sunflower oil in a Falcon tube (dimension 1.5 cm×10 cm) and placed in an oven at 30° C. Reference Brazilian nut paste was also placed in a cylindrical Falcon tube (dimension 1.5 cm×10 cm) and placed in an oven at 30° C. The percentage of free oil at the surface was measured. After 4 days, 6% oiling out was observed for the food coating mixture, while 20% of oiling out was observed for the Brazilian nut paste on its own.

### Example 2

75% peanut paste (palm oil free, from Bredabest, Netherland), 16% peanut flour and 9% Olive oil were mixed using a Thermomix at a speed of 5 during 3 minutes at room temperature. A homogenous mixture was formed. Peanut paste contains about 28% protein, 12% carbohydrate, 48.5% of fat and 7% fibre. Peanut flour is partially defatted and contains about 50% protein, 12% fat and 16% fibres.

Part of the sample was analysed. Rheology results of the mixture including peanut paste, peanut flour and olive oil were compared to the rheology results of the starting materials (peanut paste). Viscosity was measured using a Physica MCR 501 (Anton Paar) with a Pelletier temperature at 25° C., with 50 points for 6 seconds for a shear rate of 0.1 to 100 s-1. A plate to plate geometry was used.

At a shear rate of 1 s-1, viscosity for the peanut paste on its own was 13551 mPa s while viscosity for the food coating was 22912 mPa s. At a shear rate of 10 s-1, viscosity for the peanut paste on its own was 5558 mPa s while viscosity for the food coating was 9961 mPa s. At a shear rate of 100 s-1, viscosity for the peanut paste on its own was 3701 mPa s while viscosity for the food coating was 5440 mPa s.

Oiling out was measured by placing the food coating including peanut paste, peanut flour and olive oil in a cylindrical vial (dimension 0.5 cm×10 cm) and placing it in an oven at 30° C. the same was done for the reference peanut paste. The percentage of free oil at the surface was measured over time. After 6 days, no oiling out of the food coating (mixture of peanut paste, peanut flour and olive oil) could be observed while about 1% of oiling out could be observed for the reference peanut paste.

### Example 3

85% peanut paste (Bredabest, Netherland), 8% peanut flour and 7% Canola oil were mixed using a Thermomix at a speed of 5 during 3 minutes at room temperature. An homogenous mixture was formed. Peanut paste contains about 28% protein, 12% carbohydrate, 48.5% of fat and 7% fibre. Peanut flour is partially defatted and contains about 50% protein, 12% fat and 16% fiber. Oiling out was measured by placing the mixture including peanut paste, peanut flour and olive oil in a cylindrical Falcon tube (dimension 1.5 cm×10 cm). Reference ground nut paste was also placed in a cylindrical Falcon tube (dimension 1.5 cm×10 cm). The two tubes were placed in an oven at 30° C. The percentage of free oil at the surface was measured over time. After 6 days, no oiling out could be observed for the food coating (mixture peanut paste, peanut flour, canola oi) while about 1% oiling out was observed in the reference peanut paste.

### Example 4

85% peanut paste (Bredabest, Netherland), 12% sunflower flour (Heliaflor 45, AOT, Germany) and 3% canola oil were mixed using a Thermomix at a speed of 5 during 3 minutes at room temperature.

Part of the Sample was analysed by rheology. Rheology results of the mixture including Brazilian nut, sunflower flour and high oleic sunflower oil were compared to the rheology results of the starting materials (peanut paste. Viscosity was measured using a Physica MCR 501 (Anton Paar) with a Pelletier temperature at 25° C., with 50 points for 6 seconds for a shear rate of 0.1 to 100 s-1. A plate to plate geometry was used.

At a shear rate of 1 s-1, viscosity for the peanut paste was 13551 Pa s-1 while viscosity of the complete food coating was 44780 mPa s-1. At a shear rate of 10 s-1, viscosity for the peanut paste on its own was 5558 mPa s while viscosity of the complete food coating was 16500 mPa s. At a shear rate of 100 s-1, viscosity for the peanut paste on its own was 3701 mPa s while viscosity of the complete food coating was 6604 mPa s.

### Example 5

42% Brazilian nuts, 28% cashew nuts, 6% carrot flour and 24% Olive oil were mixed using a Thermomix at a speed of 5 during 3 minutes at room temperature. A homogenous mixture was formed. Brazilian nut paste was obtained using a Thermomix at a speed of 5 during 3 minutes at room temperature. A homogenous mixture was formed. Cashew nut paste was obtained using a Thermomix at a speed of 5 during 3 minutes at room temperature. A homogenous mixture was formed. Part of the Sample was analysed. Rheology results of the mixture including peanut paste, peanut flour and olive oil were compared to the rheology results of the starting materials (peanut paste).

Viscosity was measured using a Physica MCR 501 (Anton Paar) with a Pelletier temperature at 25° C., with 50 points for 6 seconds for a shear rate of 0.1 to 100 s-1. A plate to plate geometry was used.

At a shear rate of 1 s-1, viscosity for the Brazilian nut paste on its own was 3084 mPa s, viscosity for the cashew butter paste was 134315 mPa s. Calculated viscosity of the Brazilian paste and Cashew nut paste was obtained by averaging the viscosity of the mixture of cashew butter and Brazilian nut butter and taking into account the respective weight; viscosity of the mixture using the following formula (0.42*VB+0.28 VC)/(0.42+0.28) where VB is the viscosity of the Brazilian nut butter and VC is the viscosity of the cashew nut butter. Calculated viscosity of cashew nut paste and Brazilian nut paste mixed together was 55576 mPa s. Viscosity for the total food coating mixture (containing cashew nut, Brazilian paste, olive oil and sunflower flour) was 1496 mPa s. This food coating viscosity was much lower than the food coating viscosity of the Brazilian nut paste on its own, of the cashew nut paste on its own and on the calculated viscosity of the Brazilian paste and Cashew nut paste.

At a shear rate of 10 s-1, viscosity for the Brazilian nut paste on its own was 1937 mPa s, viscosity for the cashew butter paste was 32090 mPa s. Calculated viscosity of cashew nut paste and Brazilian nut paste mixed together (obtained in the way explained previously) was 13999 mPa s. Viscosity for the total food coating mixture (containing cashew nut, Brazilian paste, olive oil and sunflower flour) was 973 mPa s. This food coating viscosity was much lower than the food coating viscosity of the Brazilian nut paste on its own, of the cashew nut paste on its own and on the calculated viscosity of the Brazilian paste and Cashew nut paste.

At a shear rate of 100 s-1, viscosity for the Brazilian nut paste on its own was 1617 mPa s, viscosity for the cashew butter paste was 13908 mPa s. Calculated viscosity of cashew nut paste and Brazilian nut paste mixed together (obtained in the way explained previously) was 6533 mPa s.

Viscosity for the total food coating mixture (containing cashew nut, Brazilian paste, olive oil and sunflower flour) was 825 mPa s. This food coating viscosity was much lower than the food coating viscosity of the Brazilian nut paste on its own, of the cashew nut paste on its own and on the calculated viscosity of the Brazilian paste and Cashew nut paste.

Oiling out was measured by placing the mixture including cashew nut, brazilian nut, olive oil and sunflower flour in a Falcon tube (dimension 1.5 cm×10 cm), placing it in an oven at 30° C. and measuring the percentage of free oil at the surface over time. After 4 days, 10% of oiling out could be observed for the food coating mixture (containing cashew nut, Brazilian paste, olive oil and sunflower flour).

### Example 6

A first recipe comprising 75% peanut paste (palm oil free, from Bredabest, Netherland), 24.75% peanut flour and 0.25% olive oil is mixed using a Thermomix at a speed of 5 for a duration of 3 minutes at room temperature. A second recipe comprising 85% peanut paste (palm oil free, from Bredabest, Netherland) and 25% peanut flour is treated in the same way. Both mixtures are difficult to process with standard factory equipment and have poor mouthfeel due to the high amount of flour and no or only low amounts of oil.

1. A foodstuff comprising a food coating on its exterior surface, wherein said food coating comprises
i) between 50% and 95% of a nut paste or legume paste;
ii) between 1% and 30% of a liquid oil, wherein said liquid oil is not from the same plant source as the paste; and
iii) between 5% and 30% of a flour; and
the food coating does not comprise palm oil, and wherein between 5 to 100% of the foodstuff exterior surface is in direct contact with the food coating.

2. The foodstuff according to claim 1, wherein said food coating comprises
i) between 60% and 95% of a nut paste or legume paste;
ii) between 2% and 20% of a liquid oil; and
iii) between 6% and 25% of a flour.

3. The foodstuff according to claim 1, wherein the foodstuff and/or the food coating do not comprise animal or animal-derived products.

4. The foodstuff according to claim 1, wherein the ratio of liquid oil:flour is between 3:2 to 1:3.

5. The foodstuff according to claim 1, wherein the flour, or the flour and liquid oil combined, have a saturated fat content less than 9%.

6. The foodstuff according to claim 1, wherein the flour has a D50 diameter in the range of 5 to 150 microns as measured by light scattering.

7. The foodstuff according to claim 1, wherein the liquid oil is selected from the group consisting of sunflower oil, canola oil, colza oil, rapeseed oil, soya oil, olive oil, pumpkin oil, rapeseed oil, linseed oil, Hemp oil, chia oil, high oleic sunflower oil, peanut oil, soy bean, safflower oil, corn oil, algae oil, cottonseed oil, grape seed oil, flaxseed oil, rapeseed oil, primrose oil, linseed oil, avocado oil, a nut oil such as hazelnut oil, walnut oil, macadamia nut oil, or other nut oil, rice bran oil, sesame oil, and combinations thereof.

8. The foodstuff according to claim 7, wherein the liquid oil is a high oleic liquid oil.

9. The foodstuff according to claim 1, wherein the flour is derived from a legume, a vegetable or an oilseed source.

10. The foodstuff according to claim 1, wherein the flour contains less than 15% lipid.

11. A method of making a coated foodstuff, said method comprising the application of a food coating on an exterior surface of the foodstuff, wherein the food coating is made by mixing (i) nuts or legume seeds with liquid oil and flour; or (ii) nut paste or legume paste with liquid oil and flour.

12. The method according to claim 11, wherein the mixing step comprises a mixing step selected from the group consisting of a high shear mixing, milling, grinding and micronizing.

13. The method according to claim 12, wherein the mixing step is performed using a device selected from the group consisting of a mixer, a high shear mixer, a mixer using a blade and an extrusion machine.

14. The method according to claim 11, said method comprising the steps of mixing nut paste or legume paste with at least a portion of liquid oil, refining the mixture, combining with flour and remaining oil.

15. The method according to claim 11, wherein the foodstuff comprises an ingredient selected from the group consisting of chocolate, potatoes, and cereals.
